(19) United States
(12) Patent Application Publication
(10) Pub. No.: US 2021/0313611 A1
(43) Pub. Date: Oct. 7, 2021

(54) Method of Electrochemical Energy Storage Device Construction

(71) Applicant: SOUTH 8 TECHNOLOGIES, INC., San Diego, CA (US)

(72) Inventors: Cyrus S. Rustomji, La Jolla, CA (US); Jungwoo Lee, San Diego, CA (US); James Royer, San Diego, CA (US)

(21) Appl. No.: 17/326,093

(22) Filed: May 20, 2021

Related U.S. Application Data
(63) Continuation of application No. PCT/US20/26086, filed on Apr. 1, 2020.

(51) Int. Cl. H01M 10/04; H01M 50/636; H01M 4/04; H01M 4/36; H01M 4/62

(52) U.S. Cl. CPC H01M 10/04; H01M 50/636; H01M 4/0402; H01M 4/0471; H01M 4/366; H01M 4/62; H01M 4/043

(57) ABSTRACT

Disclosed is a novel method for constructing an electrochemical energy storage cell with a first and a second electrode. The method includes (a) coating the first electrode with a first electrolyte component to form a first coated electrode embedded within the first electrolyte component; (b) inserting the first coated electrode and the second electrode into a cell housing; (c) sealing the cell housing, wherein the cell housing comprises a solvent injection port; (d) injecting a liquefied gas solvent into the cell through the solvent injection port, wherein the solvent has a vapor pressure above an atmospheric pressure of 100 kPa at a temperature of 293 0.15 K; and (e) sealing the solvent injection port. This method can be modified in step (d) to include the injection of a liquid solvent.

### 1.0 PRIORITY CLAIM AND RELATED PATENT APPLICATIONS

This patent claims priority as a continuation to PCT/US2020/26086 entitled “METHOD OF ELECTROCHEMICAL ENERGY STORAGE DEVICE CONSTRUCTION,” filed on Apr. 1, 2020, which claims priority to U.S. Patent Application No. 62/800955 filed on Feb. 4, 2019 and entitled “METHOD OF ELECTROCHEMICAL ENERGY STORAGE DEVICE CONSTRUCTION”. The entire contents of each of these applications incorporated by reference in this document.

This patent is related to U.S. patent application Ser. No. 16/804,207 filed on Feb. 28, 2020; U.S. patent application Ser. No. 15/036,763 filed on May, 13, 2016; International Application No PCT/US2014/066015 filed on Nov. 17, 2014; U.S. Patent Application No. 61/905,057 filed on Nov. 15, 2013; U.S. Patent Application No. 61/972,101 filed on Mar. 28, 2014; International Application No. PCT/US2019/032413 filed on May 15, 2019; U.S. Provisional Application No. 62/673,792 filed on May 18, 2018; U.S. application Ser. No. 15/036,763 filed on May 13, 2016; PCT/US17/29821 filed on Apr. 27, 2017; U.S. application Ser. No. 16/305,034 filed on Nov. 28, 2018; PCT/US2019/032414 filed on May 15, 2019; U.S. Provisional Application No. 62/673,752 filed on May 18, 2018; U.S. Provisional Application No. 62/749,046 filed on Oct. 22, 2018; U.S. Provisional Application No. 61/972,101 filed on Mar. 28, 2014; U.S. Provisional Application No. 61/905,057 filed on Nov. 15, 2013; and U.S. application Ser. No. 16/793,190 filed on Feb. 18, 2020. The entire contents of each of these applications are incorporated by reference in this document.

### 2.0 TECHNICAL FIELD

This document relates to the construction of electrochemical energy storage devices that use a liquefied gas solvent or a liquid solvent.

### 3.0 BACKGROUND

The energy density of batteries is proportional to the operating voltage. In supercapacitors (i.e., electrochemical double-layer capacitors), the energy density is proportional to the voltage squared. With a greater demand for increased energy densities in electrochemical energy storage devices, significant improvements can be made by increasing the voltage ratings of such devices. An important contributing factor to the voltage limitation of electrochemical energy storage devices is the stability of the electrolyte solvent. At increased voltages, the electrolyte solvent may break down and increase in resistance. As a result, loss of charge storage capability (capacity), gassing and device end of life may be reached. Therefore, improvements in the voltage rating of such devices highly depends on the electrolyte system used. Increasing the oxidation resistance of solvents may widen the potential window of the electrolyte, defined as the potential difference between which significant oxidation and reduction current occurs, and can be very useful in electrochemical applications such as batteries, supercapacitors, chemical sensing and common reduction-oxidation electrochemistry.

Conventional electrochemical energy storage devices, such as batteries and double layer capacitors, utilize an ionic conducting electrolyte solution to carry charge between a set of positive and negative electrodes. Typically, these electrolytes are a liquid at a standard room temperature of +20 C and at standard pressure (approximately 1.01325 bar). The electrolyte solutions use a mixture of some amount of liquid solvent and salt and additional components, or additives, for improved electrochemical stability of the device. These liquid electrolyte components are premixed, then injected into the device or cell through an electrolyte injection port of the housing containing the electrode components, which is typically wound cylindrically or stacked in sheets.

Recently published prior art has disclosed electrochemical devices utilizing electrolytes with liquefied gas solvents. The introduction of liquefied gas solvents into electrochemical devices may require a different filling process for the electrolyte solution. Conventional electrochemical devices utilizing liquid solvents may use any suitable liquid phase transfer mechanism to fill the device, such as the addition of a known volume of electrolyte solution through a pipette. But in previous devices, electrodes and salts were placed inside the cell but not premixed together. After introducing a liquefied gas solvent, the salt and liquefied gas would mix to create a liquefied gas electrolyte mixture. However, this electrolyte could take several hours or days to completely and uniformly mix throughout the cell, including within the electrode and separator materials.

What is needed is a construction method that quickly allows the components of the electrolyte to become uniformly mixed. This eliminates the time needed to be taken in waiting for the cell electrolyte to completely diffuse throughout the cell, lowering manufacturing cost, improving cell-to-cell uniformity, and allowing for increased performance of the cell, including its power and energy metrics.

### 4.0 SUMMARY

The current invention describes a method in which the salt and other electrolyte components are already uniformly distributed throughout the cell because they are premixed within the electrode material. Upon addition of liquefied gas solvent, the salt and liquefied gas mix to create a liquefied gas electrolyte mixture that is immediately uniformly mixed throughout the entire cell including within the electrode and separator materials. This eliminates the time required to wait for the cell electrolyte to completely diffuse throughout the cell, lowering manufacturing cost, improving cell-to-cell uniformity, and allowing for increased performance of the cell, including its power and energy metrics.

Specifically, a method of constructing an electrochemical energy storage device or cell with a first and a second electrode is disclosed. The method includes (a) coating the first electrode with a first electrolyte component to form a first coated electrode embedded with the first electrolyte component; (b) inserting the first coated electrode and the second electrode into a cell housing; (c) sealing the cell housing, wherein the cell housing comprises a solvent injection port; (d) injecting a liquefied gas solvent into cell through the solvent injection port, wherein the solvent has a vapor pressure above an atmospheric pressure of 100 kPa at a temperature of 293.15 K; and (e) sealing the solvent injection port. This method can be modified in step (d) to include the injection of a solvent that is a liquid at standard room temperature and pressure.

Step (a) of the method may be a wet or dry coating process. In a wet coating process, the method includes: (a)(1) preparing a slurry with the first electrolyte component; (a)(2) applying the slurry to a metallic substrate; and (a)(3) heating the metallic substrate to form the first coated electrode. In a dry coating process, the method includes: (a)(1) preparing a dry mixture with the first electrolyte component; and (a)(2) pressing the dry mixture onto the metallic substrate to form the first coated electrode. The dry process may further include coating a metallic substrate with a binder prior to step (a)(2). Under either the wet or dry coating process, the first coated electrode may be compressed to improve adhesion to the metallic substrate.

Prior to step (b), the method may include coating the second electrode with a second electrolyte component, such that the second electrode is embedded within the second electrolyte component, and combining the first coated electrode and the second electrode.

Two or more liquefied gas solvents may be injected. The first electrolyte component may include a salt or a non-salt component, and may be a solid or a liquid. The gas solvent may act as a carrier gas to transport a liquid electrolyte component into the cell. Step (d) of the method may further include pressurizing the liquefied gas solvent to a pressure above the vapor pressure prior to injecting the liquefied gas solvent into cell.

Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### 5.0 BRIEF DESCRIPTION OF THE DRAWINGS

FIG. 1 is a flowchart illustrating the wet coating process.

FIG. 2 is a flowchart illustrating the dry coating process.

FIG. 3 is a flowchart illustrating a method of constructing an electrochemical energy storage device in which both electrodes are coated with one or more electrolyte components, followed by liquefied gas solvent injection to the cell.

FIG. 4 is a flowchart illustrating a method of constructing an electrochemical energy storage device in which both electrodes are coated with one or more electrolyte components, and an additional electrolyte component is added to the electrodes while in the cell housing, followed by liquefied gas solvent injection to the cell.

FIG. 5 is a flowchart illustrating a method of constructing an electrochemical energy storage device in which one electrode is coated with one or more electrolyte components embedded within the electrode followed by: (1) a single liquefied gas solvents injection; (2) two or more liquefied gas solvent injections; or (3) one or more liquefied gas solvent injections being used as a carrier gas for one or more liquid electrolyte components.

FIG. 6 is a flowchart illustrating a method of constructing an electrochemical energy storage device in which both electrodes are coated with one or more electrolyte components, followed by liquid solvent injection to the cell and an optional liquefied gas solvent injection into the cell.

FIG. 7 is a flowchart illustrating a method of constructing an electrochemical energy storage device in which one electrode is coated with one or more electrolyte components embedded within the electrode, followed by liquid solvent injection to the cell.

### 6.0 DETAILED DESCRIPTION

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention, as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order to not unnecessarily obscure the present invention. Various techniques and mechanisms of the present invention will sometimes be described in singular form for clarity. However, it should be noted that some embodiments include multiple iterations of a technique or multiple mechanisms, unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection, unless otherwise noted.

Current electrochemical cell construction dictates placing the metallic substrate (also known as a current collector) into the electrochemical cell housing, and then injecting the salt and non-salt electrolyte components and solvent into the cell housing. The solvent may be liquid at an atmospheric pressure of 100 kPa and at a room temperature of 293.15 K, or it may be a liquefied gas solvent that is gaseous at this temperature and pressure.

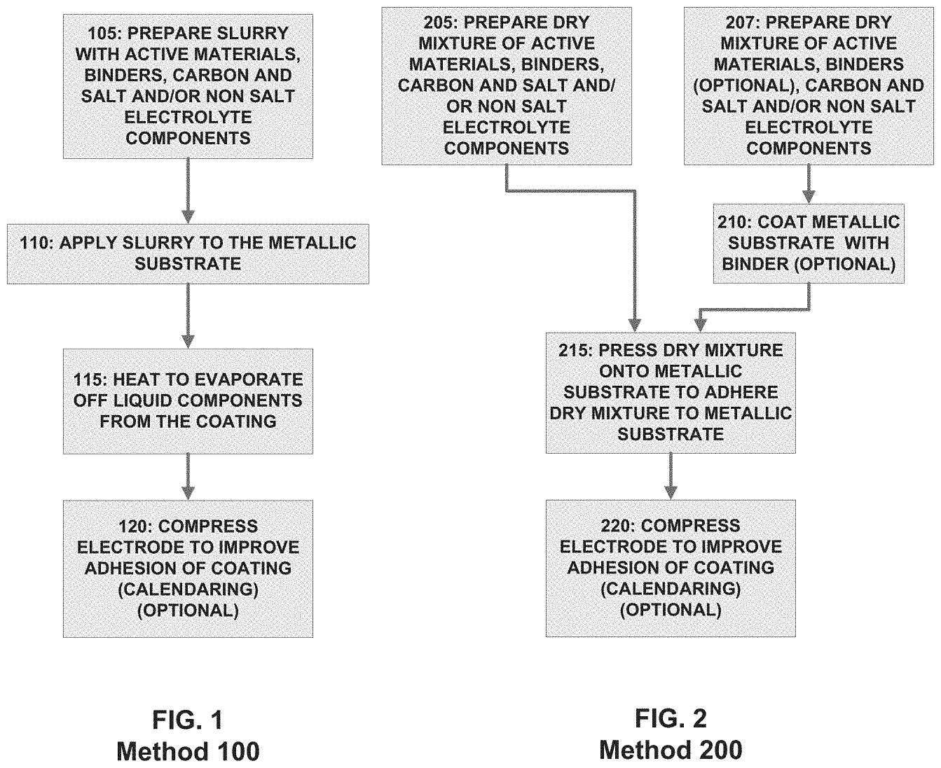

The disclosed method provides that one or both of the electrodes are coated with the electrolyte component (salt and/or non-salt) before placing the coated electrode into the electrochemical cell housing, then injecting the cell with solvent (either gaseous or non-gaseous). Specifically, the method may be performed by a wet or dry coating process. FIG. 1 illustrates the wet process 100, where a slurry is prepared with active materials (such as metal oxides), binders, carbon and salt and non-salt electrolyte components in step 105. The slurry is applied to the metallic substrate in step 110; the application may be by a doctor blade process. The coated electrode is then heated to evaporate the liquid components from the coating in step 115. The wet coating method 100 may further include an optional calendaring step 120, where the electrode is compressed together to improve adhesion to the metallic substrate to improve the life of the cell, increase the electrical connectivity between particles in the electrode, improve the cell's power and energy performance, and increase the volumetric utilization of the electrode within the cell.

FIG. 2 illustrates the dry process 200, where a dry mixture is made of the active materials (such as metal oxides), binders, carbon and salt and non-salt electrolyte components in step 205. The dry mixture is pressed onto the metallic substrate in step 215 to adhere the dry mixture to the substrate. Alternatively, the method may have an intermediate step, where the metallic substrate is coated with a dry binder at step 210. When this intermediate step is used, the dry mixture in step 207 that should occur prior to the intermediate step of 210 may or may not contain a binder as well. The dry coating method 200 may further include an optional calendaring step 220, where the electrode is compressed together to improve adhesion to the metallic substrate.

The electrodes may be combined and electrically separated with a separator material, by either winding, as in a cylindrical cell, or stacking, as in a flat cell. The term “combined” is used here to mean wounding or stacking of the electrodes. As disclosed below, the coating process may be performed on one or both of the electrodes, and the electrodes are combined and inserted into the electrochemical cell housing, where the housing is sealed, and the solvent is injected into the cell.

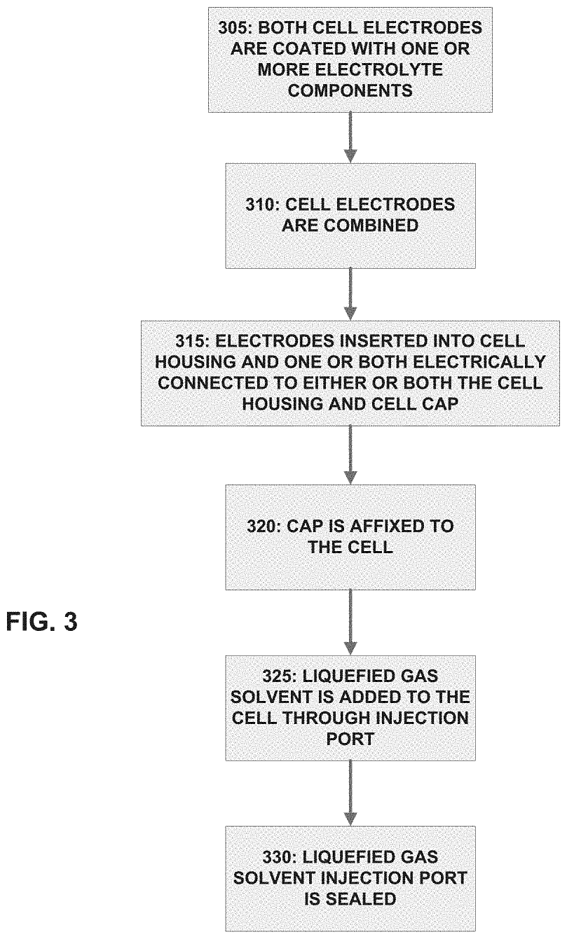

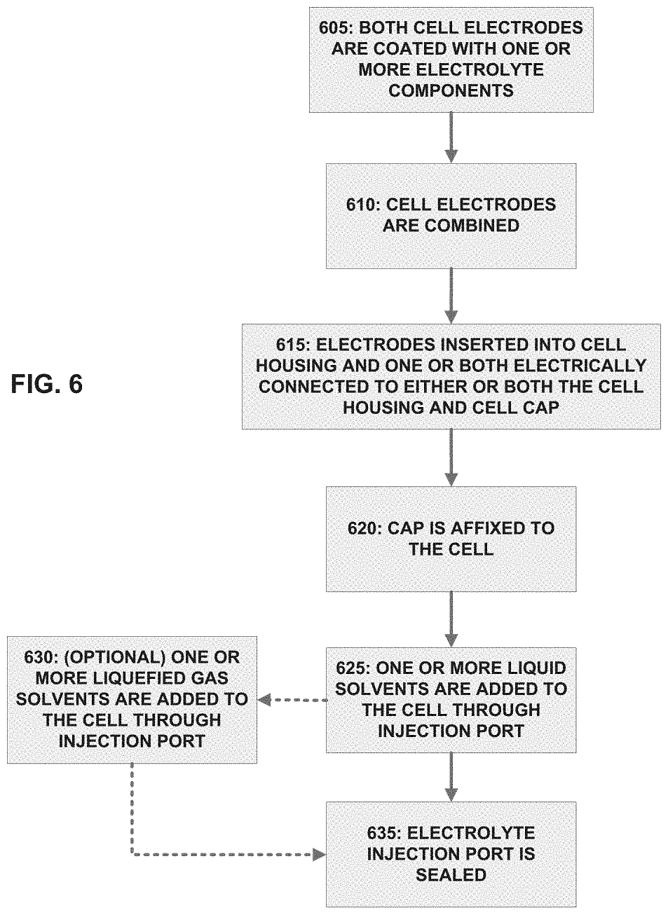

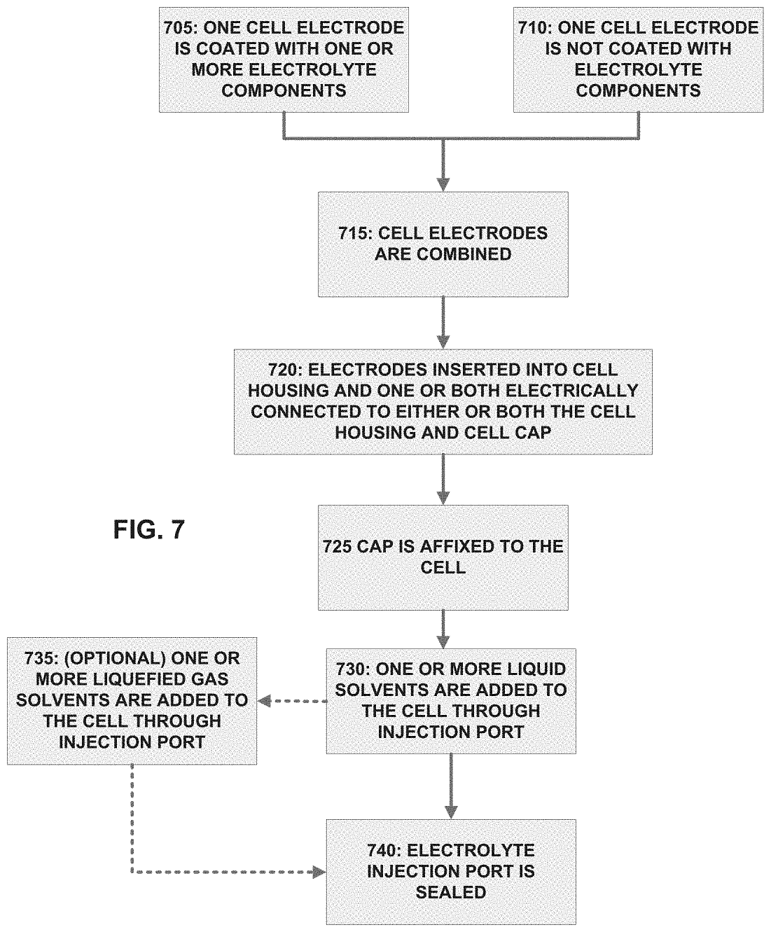

FIGS. 3-5 illustrate various, non-limiting process flowcharts for a construction of an electrochemical energy storage device (using the coating methods described herein) and featuring liquefied gas solvents, whereas FIGS. 6 and 7 use a liquid solvent. FIG. 3, for example, discloses coating both cells with one or more electrolyte components in step 305, combining the electrodes (step 310), after which they are inserted into the cell housing and electrical connections may be made (step 315). The cell is then capped at step 320, and a liquefied gas solvent is injected into the cell (step 325) before the injection port is sealed (330).

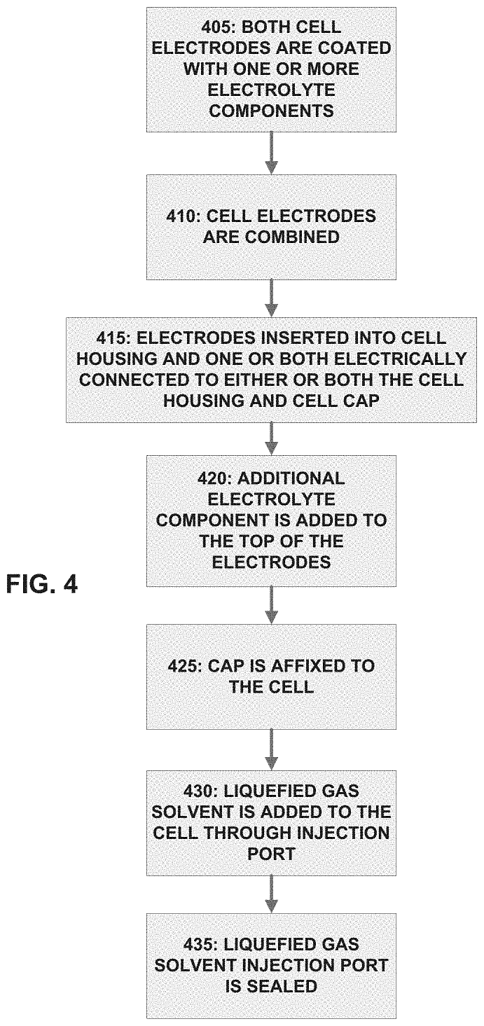

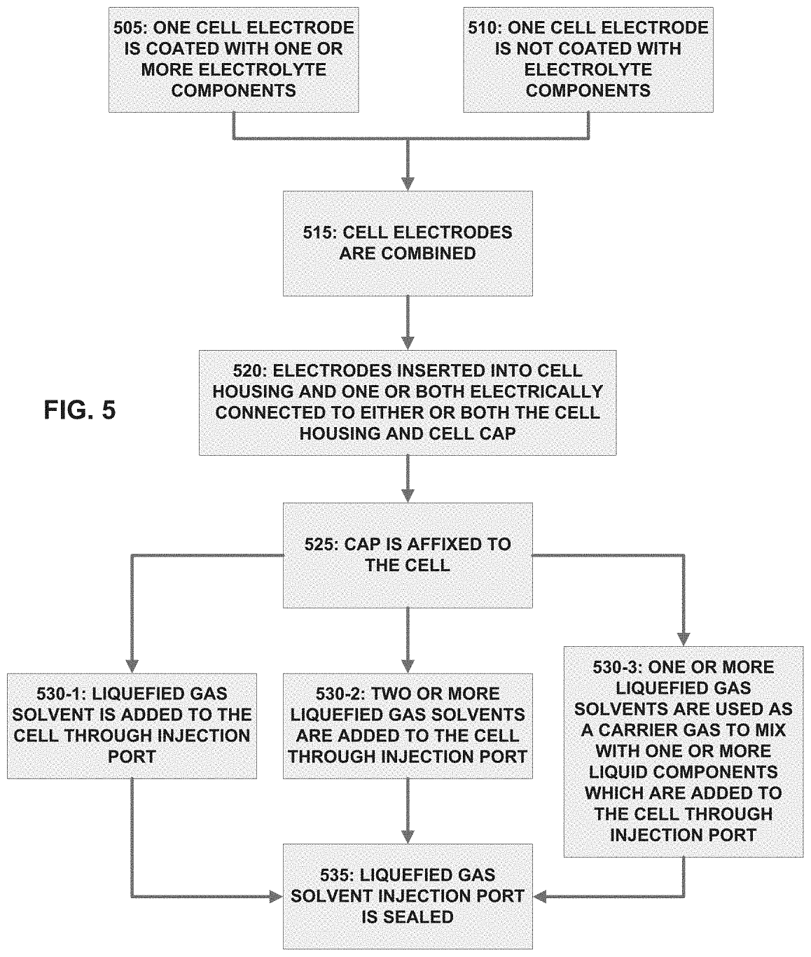

It is also possible that, after coating and after the electrodes have been placed in the electrochemical cell housing, additional electrolyte components may be introduced in addition to the gaseous solvent. This is shown in FIG. 4 at step 420. This may be useful when, for example, the additional electrolyte component may be a liquid, and it may not be possible to add the additional electrolyte component to the coating because the drying step may cause the additional electrolyte component to evaporate. To overcome this, the electrode may be coated with the one or more electrolyte components and dried (step 405), before the electrodes are combined (step 410) and placed in the housing (step 415). Then, the additional electrolyte component may be added in step 420. This additional electrolyte component may alternatively be added as part of the liquefied gas injection (see FIG. 5, step 530-3). After step 420, the cap is affixed to the cell (step 425), the liquefied gas solvent is added to the cell through an injection port (step 430), and the liquefied gas solvent injection port is then sealed (step 435), similar to steps 320, 325, 330.

In FIG. 5, only one of the electrodes is coated with the one or more electrolyte components. See steps 505 and 510. The electrodes are combined in step 515, and the combined electrodes are inserted into the cell and the electrical connections are made (step 520). The cell is capped at step 525. At this point, the liquefied gas solvent is introduced in one of the following steps 530-1, 530-2, or 530-3: in step 530-1, a single liquefied gas solvent is injected through the injection port; in step 530-2, two or more liquefied gas solvents are injected through the injection port; in step 530-3, one or more liquefied gas solvents may be used as a carrier gas to mix with one or more liquid components, which can be added to the cell through injection port. To facilitate using the carrier gas method of step 530-3, the additional electrolyte component liquid can be mixed with the liquefied gas solvent forming a liquid/gas solvent mixture, and that mixture may be heated so that the liquid component boils off such that the solvent mixture becomes a gas/gas mixture that is then injected into the electrochemical cell. Alternatively, the mixture is not heated, and the liquid/gas mixture is injected into the cell. It should be noted that these same three alternative steps (i.e., 530-1, 530-2, 530-3) may be used in FIG. 3 (at step 325) and FIG. 4 (at step 430). After injection, the injection port is sealed at step 535.

The liquefied gas solvent may be added into the cell through the liquefied gas injection port in either the gas phase or in the liquid phase. The gas phase addition would happen at pressures below the vapor pressure of the liquefied gas solvent, and the liquid phase addition would happen at pressures at or above the vapor pressure of the liquefied gas solvent. This gas or liquid phase addition can be done with one or more mixed liquefied gas solvents and may further be mixed with one or more liquid solvents.

While the above method discloses using a liquefied gas solvent as part of the electrochemical construction (see e.g. steps 325, 430, 530-1, 530-2, 530-3), it is also possible to use a liquid solvent instead. This would still eliminate the time needed to wait for the cell electrolyte to completely diffuse throughout the cell, lowering manufacturing cost, improving cell-to-cell uniformity, and allowing for increased performance of the cell, including the cell's power and energy metrics.

FIG. 6 illustrates a non-limiting process flowchart for a construction of an electrochemical energy storage device using the coating methods described herein and with a liquid solvent. Steps 605 through 620 are the same as the steps described above with respect to FIG. 3 steps 305-320. At step 625, one or more liquid solvents can be added to the cell through the injection port. Optionally, one or more liquefied gas solvents may also be added through the injection port (step 630). The injection port is then sealed at step 635, which may follow either step 625 or step 630, depending on whether optional step 630 is taken.

FIG. 7 illustrates yet another non-limiting process flowchart for a construction of an electrochemical energy storage device using the coating methods described herein and with a liquid solvent. Steps 705 through 725 are the same as the steps described above with respect to FIG. 5 steps 505-525. At step 730, one or more liquid solvents are added to the cell through the injection port. Optionally, one or more liquefied gas solvents may also be added through the injection port (step 735). The injection port is then sealed at step 740, which may follow either step 730 or 735, depending on whether optional step 735 is taken.

The method can be used with dry or wet electrolyte component coatings, and those may include salt or non-salt components, or combinations of both. One or both electrodes may be coated. The coated electrode may contain less than about 1%, or up to about 3%, 5%, 10%, 20%, 30%, 40%, 50%, 60%, 70%, or 80% by weight based on the total weight of the coated electrode of a salt or non-salt component. One or more liquefied gas solvent components may be added to the cell either simultaneously or sequentially, as a liquefied gas solvent mixture.

One or both electrodes may be any combination of metal, alloy, intercalation, electrostatic, conversion, or chemical reaction types. One or both electrodes may contain a conductive additive component in order to maintain electrical conductivity of the electrode, including carbon, activated carbon, graphene, carbon nanotubes, carbon black, acetylene black, or any combination thereof. One or both electrodes may contain binder polymer components in order to maintain structural integrity of the electrode, including polyvinylidene fluoride, carboxymethyl cellulose, styrene-butadiene rubber, polytetrafluoroethylene, or any combination thereof. One or both electrodes may be of conversion or chemical reaction type, which can maintain chemical reactions or conversions with binary compounds of formula MxBy, where M can be titanium, vanadium, chromium, manganese, iron, cobalt, nickel, copper, or carbon, and B can be nitrogen, oxygen, sulfur, or fluorine and x can be 1, 2, 3, 4, or 5 and y can be 1, 2, 3, 4, or 5, or any combination thereof of M components and B components with any combination of x and y ratios. One or both electrodes may be of a chemical reaction type that has chemical reactions between the electrolyte and chemicals of sulfur, oxygen, carbon dioxide, nitrogen, sulfur dioxide, thionyl fluoride, thionyl chloride fluoride, thionyl chloride, sulfuryl fluoride, sulfuryl chloride fluoride, sulfuryl chloride, or carbon fluoride, or any combination thereof, where any of the chemicals may be a component of either the electrolyte of the electrode, or a combination of both, and a chemical reaction takes place on an electrode surface such as a high surface area carbon material surface. One or both electrodes may be of an electrostatic type, such as a high surface area carbon material, activated carbon, graphene, carbon nanotubes, carbon black, acetylene black, or any combination thereof. One or both electrodes may be of an intercalation type, such as graphite, carbon, activated carbon, lithium titanate, titanium disulfide, molybdenum disulfide, lithium iron phosphate, lithium cobalt phosphate, lithium nickel phosphate, lithium cobalt oxide, lithium nickel manganese oxide, lithium manganese oxide, lithium nickel manganese cobalt oxide, lithium nickel cobalt aluminum oxide, carbon fluoride or any combination thereof. One or both electrodes may be of an alloying type such as tin, aluminum, silicon, which may alloy with lithium, sodium, magnesium, zinc, or any combination thereof. One or both electrodes may be of a metal type, such as lithium, sodium, magnesium, zinc, copper, nickel, titanium, aluminum, gold, platinum, silver or any combination thereof.

The method can be used with a non-salt solid or liquid component that consists of one or more of: ethylene carbonate, fluoroethylene carbonate, chloroethylene carbonate, vinylene carbonate, crown ethers, tetrahydrofuran, 2-methyl-tetrahydrofuran, acetonitrile, triethyl phosphate, trimethyl phosphate, vinyl acetate, divinyl adipate, methyl vinyl carbonate, allyl acetate, allyl methyl carbonate, lactone, methyl propargyl carbonate, propargyl acetate, 2-butyne-1,4-diol dimethyl decarbonate, methyl propargyl carbonate, succinic anhydride, maleic anhydride, silicon oxide, silica gel, alumina silicate, diethyl oxalate, ethyl methyl oxalate, 1,4-butane sultone, 1,3-propane sultone, 3-hydroxypropanesulfonic acid, N-methylpyrrolidone, N-Methyl-2-pyrrolidone, 1,3-propene sultone, methylene methanedisulfonate, ethylene methanedisulfonate, ethylene sulfite, dipropargyl sulfite, ethylene sulfate, vinylene sulfate, diallyl sulfate, benzyl methyl sulfate, bis(trimethylsilyl) sulfate, dipropargyl sulfate, dimethylsulfone, trifluoromethyl ethylene carbonate, triallyl phosphate, tripropargyl phosphate, ethyl diethylphosphinate, 1,3-dioxolane, succinonitrile, sebaconitrile, combinations thereof, and isomers thereof.

The method can be used with a salt solid or liquid component that consists of one or more of: lithium bis(trifluoromethanesulfonyl)imide (LiTFSI), lithium hexafluorophosphate, lithium perchlorate, lithium hexafluoroarsenate, lithium tetrachloroaluminate, lithium tetragaliumaluminate, lithium bis(oxalato)borate, lithium hexafluorostannate, lithium difluoro(oxalato)borate, lithium bis(fluorosulfonyl)imide, lithium aluminum fluoride, lithium chloroaluminate, lithium tetrafluoroborate, lithium tetrachloroaluminate, lithium difluorophosphate, lithium tetrafluoro(oxalato)phosphate, lithium difluorobis(oxalato)phosphate, lithium borate, lithium oxolate, lithium thiocyanate, lithium tetrachlorogallate, lithium chloride, lithium bromide, lithium iodide, lithium carbonate, lithium fluoride, lithium oxide, lithium hydroxide, lithium nitride, lithium super oxide, lithium azide, lithium deltate, di-lithium squarate, lithium croconate dihydrate, dilithium rhodizonate, lithium oxalate, di-lithium ketomalonate, lithium di-ketosuccinate or any corresponding salts with the positive charged lithium cation substituted for sodium, magnesium, combinations thereof, and isomers thereof.

The method can be used with a salt solid or liquid component that includes those with positively charged cations such as tetramethylammonium, tetraethylammonium, tetrapropylammonium, tetrabutylammonium, triethylmethylammonium ammonium, 1,1-dimethylpyrrolidinium, spiro-(1,1′)-bipyrrolidinium, N,N-diethyl-N-methyl-N(2methoxyethyl)ammonium, N,N-Diethyl-N-methyl-N-propylammonium, N,N-dimethyl-N-ethyl-N-(3 -methoxypropyl)ammonium, N,N-Dimethyl-N-ethyl-N-benzylAmmonium, N,N-Dimethyl-N-ethyl-N-phenylethylammonium, N-Ethyl-N,N-dimethyl-N-(2-methoxyethyl)ammonium, N-Tributyl-N-methylammonium, N-Trimethyl-N-hexylammonium, N-Trimethyl-N-butylammonium, N-Trimethyl-N-propylammonium, 1,3-Dimethylimidazolium, 1-(4-Sulfobutyl)-3-methylimidazolium, 1-Allyl-3H-imidazolium, 1-Butyl-3-methylimidazolium, 1-Ethyl-3-methylimidazolium, 1-Hexyl-3-methylimidazolium, 1-Octyl-3-methylimidazolium, 3-Methyl-1-propylimidazolium, H-3-Methylimidazolium, Trihexyl(tetradecyl)phosphonium, N-Butyl-N-methylpiperidinium, N-Propyl-N-methylpiperidinium, 1-Butyl-1-Methylpyrrolidinium, 1-Methyl-1-(2-methoxyethyl)pyrrolidinium, 1-Methyl-1-(3-methoxypropyl)pyrrolidinium, 1-Methyl-1-octylpyrrolidinium, 1-Methyl-1-pentylpyrrolidinium, N-Propyl-or N-methylpyrrolidinium paired with negatively charged anions such as acetate, bis(fluorosulfonyl)imide, bis(oxalate)borate, bis(trifluoromethanesulfonyl)imide, bromide, chloride, dicyanamide, diethyl phosphate, hexafluorophosphate, hydrogen sulfate, iodide, methanesulfonate, methyl-phophonate, tetrachloroaluminate, tetrafluoroborate, trifluoromethanesulfonate, combinations thereof, and isomers thereof.

The method can be used with liquefied gas solvents that consist of one or more of: fluoromethane, difluoromethane, trifluoromethane, fluoroethane, tetrafluoroethane, pentafluoroethane, 1,1-difluoroethane, 1,2-difluoroethane, 1,1,1-trifluoroethane, 1,1,2-trifluoroethane, 1,1,1,2-tetrafluoroethane, 1,1,2,2-tetrafluoroethane, pentafluoroethane, 1-fluoropropane, 2-fluoropropane, 1,1-difluoropropane, 1,2-difluoropropane, 2,2-fluoropropane, 1,1,1-trifluoropropane, 1,1,2-trifluoropropane, 1,2,2-trifluoropropane, fluoroethylene, cis-1,2-fluoroethylene, 1,1-fluoroethylene, 1-fluoropropylene, 2,3,3,3-tetrafluoropropene, 1,3,3,3-tetrafluoropropene, chloromethane, chloroethane, chlorofluoromethane, dichlorofluoromethane, difluorochloromethane, trichloromethane, methane, ethane, propane, butane, pentane, ethylene, propylene, butylene, thionyl fluoride, thionyl chloride fluoride, phosphoryl fluoride, phosphoryl chloride fluoride, sulfuryl fluoride, sulfuryl chloride fluoride, chlorine, fluorine, bromine, iodine, ammonia, nitrous oxide, molecular oxygen, molecular nitrogen, argon, carbon monoxide, carbon dioxide, sulfur dioxide, carbon disulfide, hydrogen fluoride, hydrogen chloride, cyanide, dimethyl ether, methyl ethyl ether, combinations thereof, and isomers thereof.

The method can be used with liquid solvents such as a non-cyclic carbonate compound selected from the group consisting of dimethyl carbonate, ethyl methyl carbonate, propyl methyl carbonate, butyl methyl carbonate, diethyl carbonate, propyl ethyl carbonate, butyl ethyl carbonate, dipropyl carbonate, propyl butyl carbonate, dibutyl carbonate, fluoromethyl methyl carbonate, difluoromethyl methyl carbonate, trifluoromethyl methyl carbonate, bis(fluoromethyl) carbonate, bis(difluoromethyl) carbonate, bis(trifluoromethyl) carbonate, fluoromethyl ethyl carbonate, difluoromethyl ethyl carbonate, trifluoromethyl ethyl carbonate, fluoroethyl ethyl carbonate, difluoroethyl ethyl carbonate, trifluoroethyl ethyl carbonate, tetrafluoroethyl ethyl carbonate, pentafluoroethyl ethyl carbonate, hexafluoroethyl ethyl carbonate, bis(fluoroethyl) carbonate, bis(difluoroethyl) carbonate, bis(trifluoroethyl) carbonate, bis(tetrafluoroethyl) carbonate, bis(pentafluoroethyl) carbonate, bis(hexafluoroethyl) carbonate, and any combination thereof.

The method can be used with liquid solvents such as a cyclic carbonate compound selected from the group consisting of vinyl carbonate, ethylene carbonate, propylene carbonate, 1,2-butylene carbonate, trans-butylene carbonate, fluoroethylene carbonate, difluoroethylene carbonate, trifluoroethylene carbonate, tetrafluoroethylene carbonate, chloroethylene carbonate, dichloroethylene carbonate, trichloroethylene carbonate, tetrachloroethylene carbonate, fluoromethyl ethylene carbonate, difluoromethyl ethylene carbonate, trifluoromethyl ethylene carbonate, bis(fluoromethyl) ethylene carbonate, bis(difluoromethyl) ethylene carbonate, bis(trifluoromethyl) ethylene carbonate, and any combination thereof.

The method can be used with liquid solvents such as a non-cyclic ether compound selected from the group consisting of methyl propyl ether, methyl butyl ether, diethyl ether, ethyl propyl ether, ethyl butyl ether, dipropyl ether, propyl butyl ether, dibutyl ether, ethyl vinyl ether, divinyl ether, glyme, diglyme, triglyme, tetraglyme, 1,1,2,2-Tetrafluoro-3-(1,1,2,2-tetrafluoroethoxy)-propane, trifluoro(trifluoromethoxy)methane, perfluoroethyl ether, fluoromethyl methyl ether, difluoromethyl methyl ether, trifluoromethyl methyl ether, bis(fluoromethyl) ether, bis(difluoromethyl) ether, fluoroethyl methyl ether, difluoroethyl methyl ether, trifluoroethyl methyl ether, bis(fluoroethyl) ether, bis(difluoroethyl) ether, bis(trifluoroethyl) ether, 2-fluoroethoxymethoxyethane, 2,2-difluoroethoxymethoxyethane, methoxy-2,2,2-trifluoroethoxyethane, ethoxy-2-fluoroethoxyethane, 2,2-difluoroethoxyethoxyethane, ethoxy-2,2,2-trifluoroethoxyethane, methyl nanofluorobutyl ether, ethyl nanofluorobutyl ether, 2-fluoroethoxymethoxyethane, 2,2-difluoroethoxymethoxyethane, methoxy-2,2,2-trifluoroethoxyethane, ethoxy-2-fluoroethoxyethane, 2,2-difluoroethoxyethoxyethane, ethoxy-2,2,2-trifluoroethoxyethane, bis(trifluoro)methyl ether, dimethylether, methyl ethyl ether, methyl vinyl ether, perfluoromethyl-vinylether, and any combination thereof.

In The method can be used with liquid solvents such as a cyclic ether compound selected from the group consisting of propylene oxide, tetrahydrofuran, tetrahydropyran, furan, 12-crown-4, 12-crown-5, 18-crown-6, 2-Methyltetrahydrofuran, 1,3-Dioxolane, 1,4-dioxolane, 2-methyloxolane, (1,2-propylene oxide), ethylene oxide, octafluorotetrahydrofuran, and any combination thereof.

The method can be used with liquid solvents such as a nitrile compound selected from the group consisting of acetonitrile, propionitrile, butanenitrile, pentanenitrile, hexanenitrile, hexanedinitrile, pentanedinitrile, butanedinitrile, propanedinitrile, ethanedinitrile, isovaleronitrile, benzonitrile, phenylacetonitrile, cyanogen chloride, hydrogen cyanide, ethanedinitrile, and any combination thereof.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments. Only a few implementations and examples are described and other implementations, enhancements and variations can be made without departing from the scope and spirit of this invention, based on what is described and illustrated in this patent document.

1. A method of constructing an electrochemical energy storage cell with a first and a second electrode, the method comprising:
a. coating the first electrode with a first electrolyte component to form a first coated electrode embedded within the first electrolyte component;
b. inserting the first coated electrode and the second electrode into a cell housing;
c. sealing the cell housing, wherein the cell housing comprises a solvent injection port;
d. injecting a liquefied gas solvent into the cell through the solvent injection port, wherein the solvent has a vapor pressure above an atmospheric pressure of 100 kPa at a temperature of 293.15 K; and
e. sealing the solvent injection port.

2. The method of claim 1, further comprising, prior to step (b):
coating the second electrode with a second electrolyte component such that the second electrode is embedded within the second electrolyte component; and
combining the first coated electrode and the second electrode.

3. The method of claim 1, wherein step (d) further comprises pressurizing the liquefied gas solvent to a pressure above the vapor pressure prior to injecting the liquefied gas solvent into cell.

4. The method of claim 1, wherein step (d) comprises injecting two or more liquefied gas solvents.

5. The method of claim 1, wherein the gas solvent acts as a carrier gas to transport a liquid electrolyte component into the cell.

6. The method of claim 1, wherein step (a) is a wet coating process that comprises the following steps:
(a)(1) preparing a slurry with the first electrolyte component;
(a)(2) applying the slurry to a metallic substrate; and
(a)(3) heating the metallic substrate to form the first coated electrode.

7. The method of claim 6, further comprising compressing the first coated electrode to improve adhesion to the metallic substrate.

8. The method of claim 1, wherein step (a) is a dry coating process that comprises the following steps:
(a)(1) preparing a dry mixture with the first electrolyte component; and
(a)(2) pressing the dry mixture onto the metallic substrate to form the first coated electrode.

9. The method of claim 8, further comprising coating a metallic substrate with a binder prior to step (a)(2).

10. The method of claim 8, further comprising compressing the first coated electrode to improve adhesion to the metallic substrate.

11. The method of claim 1, wherein the first electrolyte component comprises a non-salt component.

12. The method of claim 11, wherein the non-salt component is selected from a group consisting of: ethylene carbonate, fluoroethylene carbonate, chloroethylene carbonate, vinylene carbonate, crown ethers, tetrahydrofuran, 2-methyl-tetrahydrofuran, acetonitrile, triethyl phosphate, trimethyl phosphate, vinyl acetate, divinyl adipate, methyl vinyl carbonate, allyl acetate, allyl methyl carbonate, lactone, methyl propargyl carbonate, propargyl acetate, 2-butyne-1,4-diol dimethyl decarbonate, methyl propargyl carbonate, succinic anhydride, maleic anhydride, silicon oxide, silica gel, alumina silicate, diethyl oxalate, ethyl methyl oxalate, 1,4-butane sultone, 1,3-propane sultone, 3-hydroxypropanesulfonic acid, N-methylpyrrolidone, N-Methyl-2-pyrrolidone, 1,3-propene sultone, methylene methanedisulfonate, ethylene methanedisulfonate, ethylene sulfite, dipropargyl sulfite, ethylene sulfate, vinylene sulfate, diallyl sulfate, benzyl methyl sulfate, bis(trimethylsilyl) sulfate, dipropargyl sulfate, dimethylsulfone, trifluoromethyl ethylene carbonate, triallyl phosphate, tripropargyl phosphate, ethyl diethylphosphinate, 1,3-dioxolane, succinonitrile, sebaconitrile, combinations thereof, and isomers thereof.

13. The method of claim 1, wherein the first electrolyte component comprises a salt component.

14. The method of claim 13, wherein the salt component is selected from a group consisting of: lithium bis(trifluoromethanesulfonyl)imide (LiTFSI), lithium hexafluorophosphate, lithium perchlorate, lithium hexafluoroarsenate, lithium tetrachloroaluminate, lithium tetragaliumaluminate, lithium bis(oxalato)borate, lithium hexafluorostannate, lithium difluoro(oxalato)borate, lithium bis(fluorosulfonyl)imide, lithium aluminum fluoride, lithium chloroaluminate, lithium tetrafluoroborate, lithium tetrachloroaluminate, lithium difluorophosphate, lithium tetrafluoro(oxalato)phosphate, lithium difluorobis(oxalato)phosphate, lithium borate, lithium oxolate, lithium thiocyanate, lithium tetrachlorogallate, lithium chloride, lithium bromide, lithium iodide, lithium carbonate, lithium fluoride, lithium oxide, lithium hydroxide, lithium nitride, lithium super oxide, lithium azide, lithium deltate, di-lithium squarate, lithium croconate dihydrate, dilithium rhodizonate, lithium oxalate, di-lithium ketomalonate, lithium di-ketosuccinate or any corresponding salts with the positive charged lithium cation substituted for sodium, magnesium, tetramethylammonium, tetraethylammonium, tetrapropylammonium, tetrabutylammonium, triethylmethylammonium ammonium, 1,1-dimethylpyrrolidinium, spiro-(1,1′)-bipyrrolidinium, N,N-diethyl-N-methyl-N(2methoxyethyl)ammonium, N,N-Diethyl-N-methyl-N-propylammonium, N,N-dimethyl-N-ethyl-N-(3-methoxypropyl)ammonium, N,N-Dimethyl-N-ethyl-N-benzylAmmonium, N,N-Dimethyl-N-ethyl-N-phenylethylammonium, N-Ethyl-N,N-dimethyl-N-(2-methoxyethyl)ammonium, N-Tributyl-N-methylammonium, N-Trimethyl-N-hexylammonium, N-Trimethyl-N-butylammonium, N-Trimethyl-N-propylammonium, 1,3-Dimethylimidazolium, 1-(4-Sulfobutyl)-3-methylimidazolium, 1-Allyl-3H-imidazolium, 1-Butyl-3-methylimidazolium, 1-Ethyl-3-methylimidazolium, 1-Hexyl-3-methylimidazolium, 1-Octyl-3-methylimidazolium, 3-Methyl-l-propylimidazolium, H-3-Methylimidazolium, Trihexyl(tetradecyl)phosphonium, N-Butyl-N-methylpiperidinium, N-Propyl-N-methylpiperidinium, 1-Butyl-1-Methylpyrrolidinium, 1-Methyl-1-(2-methoxyethyl)pyrrolidinium, 1-Methyl-1-(3-methoxypropyl)pyrrolidinium, 1-Methyl-1-octylpyrrolidinium, 1-Methyl-1-pentylpyrrolidinium, N-Propyl-or N-methylpyrrolidinium paired with negatively charged anions such as acetate, bis(fluorosulfonyl)imide, bis(oxalate)borate, bis(trifluoromethanesulfonyl)imide, bromide, chloride, dicyanamide, diethyl phosphate, hexafluorophosphate, hydrogen sulfate, iodide, methanesulfonate, methyl-phophonate, tetrachloroaluminate, tetrafluoroborate, trifluoromethanesulfonate, combinations thereof, and isomers thereof.

15. The method of claim 1, wherein the first electrolyte component comprises a salt and a non-salt component.

16. The method of claim 1, wherein the first electrolyte component comprises a liquid and/or a solid component.

17. The method of claim 1, wherein the liquefied gas solvent is a selected from a group consisting of: fluoromethane, difluoromethane, trifluoromethane, fluoroethane, tetrafluoroethane, pentafluoroethane, 1,1-difluoroethane, 1,2-difluoroethane, 1,1,1-trifluoroethane, 1,1,2-trifluoroethane, 1,1,1,2-tetrafluoroethane, 1,1,2,2-tetrafluoroethane, pentafluoroethane, 1-fluoropropane, 2-fluoropropane, 1,1-difluoropropane, 1,2-difluoropropane, 2,2-fluoropropane, 1,1,1-trifluoropropane, 1,1,2-trifluoropropane, 1,2,2-trifluoropropane, fluoroethylene, cis-1,2-fluoroethylene, 1,1-fluoroethylene, 1-fluoropropylene, 2,3,3,3-tetrafluoropropene, 1,3,3,3-tetrafluoropropene, chloromethane, chloroethane, chlorofluoromethane, dichlorofluoromethane, difluorochloromethane, trichloromethane, methane, ethane, propane, butane, pentane, ethylene, propylene, butylene, thionyl fluoride, thionyl chloride fluoride, phosphoryl fluoride, phosphoryl chloride fluoride, sulfuryl fluoride, sulfuryl chloride fluoride, chlorine, fluorine, bromine, iodine, ammonia, nitrous oxide, molecular oxygen, molecular nitrogen, argon, carbon monoxide, carbon dioxide, sulfur dioxide, carbon disulfide, hydrogen fluoride, hydrogen chloride, cyanide, dimethyl ether, methyl ethyl ether, combinations thereof, and isomers thereof.

18. The method of claim 1, wherein the first coated electrode contains from 1% to 80% of the first electrolyte component by weight based on the total weight of the first coated electrode.

19. The method of claim 1, wherein the first coated electrode comprises carbon, graphite, activated carbon, graphene, carbon nanotubes, carbon black, acetylene black, lithium titanate, titanium disulfide, molybdenum disulfide, lithium iron phosphate, lithium cobalt phosphate, lithium nickel phosphate, lithium cobalt oxide, lithium nickel manganese oxide, lithium manganese oxide, lithium nickel manganese cobalt oxide, lithium nickel cobalt aluminum oxide, carbon fluoride, or any combination thereof.

20. The method of claim 1, wherein the first coated electrode comprises an metallic alloy, lithium, sodium, magnesium, zinc, copper, nickel, titanium, aluminum, gold, platinum, silver or any combination thereof.

21. A method of constructing an electrochemical energy storage cell with a first and second electrode, the method comprising:
a. coating the first electrode with a first electrolyte component to form a first coated electrode embedded within the first electrolyte component;
b. inserting the first coated electrode and the second electrode into a cell housing;
c. sealing the cell housing, wherein the cell housing comprises a solvent injection port;
d. injecting a liquid solvent into the cell through the solvent injection port; and
e. sealing the solvent injection port.

22. The method of claim 21, further comprising, prior to step (b):
coating the second electrode with a second electrolyte component such that the second electrode is embedded within the second electrolyte component; and
combining the first coated electrode and the second electrode.

23. The method of claim 21, wherein step (d) comprises injecting two or more liquid solvents.

24. The method of claim 21, wherein the liquid solvent is selected from the group consisting of dimethyl carbonate, ethyl methyl carbonate, propyl methyl carbonate, butyl methyl carbonate, diethyl carbonate, propyl ethyl carbonate, butyl ethyl carbonate, dipropyl carbonate, propyl butyl carbonate, dibutyl carbonate, fluoromethyl methyl carbonate, difluoromethyl methyl carbonate, trifluoromethyl methyl carbonate, bis(fluoromethyl) carbonate, bis(difluoromethyl) carbonate, bis(trifluoromethyl) carbonate, fluoromethyl ethyl carbonate, difluoromethyl ethyl carbonate, trifluoromethyl ethyl carbonate, fluoroethyl ethyl carbonate, difluoroethyl ethyl carbonate, trifluoroethyl ethyl carbonate, tetrafluoroethyl ethyl carbonate, pentafluoroethyl ethyl carbonate, hexafluoroethyl ethyl carbonate, bis(fluoroethyl) carbonate, bis(difluoroethyl) carbonate, bis(trifluoroethyl) carbonate, bis(tetrafluoroethyl) carbonate, bis(pentafluoroethyl) carbonate, bis(hexafluoroethyl) carbonate, vinyl carbonate, ethylene carbonate, propylene carbonate, 1,2-butylene carbonate, trans-butylene carbonate, fluoroethylene carbonate, difluoroethylene carbonate, trifluoroethylene carbonate, tetrafluoroethylene carbonate, chloroethylene carbonate, dichloroethylene carbonate, trichloroethylene carbonate, tetrachloroethylene carbonate, fluoromethyl ethylene carbonate, difluoromethyl ethylene carbonate, trifluoromethyl ethylene carbonate, bis(fluoromethyl) ethylene carbonate, bis(difluoromethyl) ethylene carbonate, bis(trifluoromethyl) ethylene carbonate, methyl propyl ether, methyl butyl ether, diethyl ether, ethyl propyl ether, ethyl butyl ether, dipropyl ether, propyl butyl ether, dibutyl ether, ethyl vinyl ether, divinyl ether, glyme, diglyme, triglyme, tetraglyme, 1,1,2,2-Tetrafluoro-3-(1,1,2,2-tetrafluoroethoxy)-propane, trifluoro(trifluoromethoxy)methane, perfluoroethyl ether, fluoromethyl methyl ether, difluoromethyl methyl ether, trifluoromethyl methyl ether, bis(fluoromethyl) ether, bis(difluoromethyl) ether, fluoroethyl methyl ether, difluoroethyl methyl ether, trifluoroethyl methyl ether, bis(fluoroethyl) ether, bis(difluoroethyl) ether, bis(trifluoroethyl) ether, 2-fluoroethoxymethoxyethane, 2,2-difluoroethoxymethoxyethane, methoxy-2,2,2-trifluoroethoxyethane, ethoxy-2-fluoroethoxyethane, 2,2-difluoroethoxyethoxyethane, ethoxy-2,2,2-trifluoroethoxyethane, methyl nanofluorobutyl ether, ethyl nanofluorobutyl ether, 2-fluoroethoxymethoxyethane, 2,2-difluoroethoxymethoxyethane, methoxy-2,2,2-trifluoroethoxyethane, ethoxy-2-fluoroethoxyethane, 2,2-difluoroethoxyethoxyethane, ethoxy-2,2,2-trifluoroethoxyethane, bis(trifluoro)methyl ether, dimethylether, methyl ethyl ether, methyl vinyl ether, perfluoromethyl-vinylether, propylene oxide, tetrahydrofuran, tetrahydropyran, furan, 12-crown-4, 12-crown-5, 18-crown-6, 2-Methyltetrahydrofuran, 1,3-Dioxolane, 1,4-dioxolane, 2-methyloxolane, (1,2-propylene oxide), ethylene oxide, octafluorotetrahydrofuran, acetonitrile, propionitrile, butanenitrile, pentanenitrile, hexanenitrile, hexanedinitrile, pentanedinitrile, butanedinitrile, propanedinitrile, ethanedinitrile, isovaleronitrile, benzonitrile, phenylacetonitrile, cyanogen chloride, hydrogen cyanide, ethanedinitrile, and any combination thereof.

25. (canceled)
